(19) United States
(12) Patent Application Publication
(10) Pub. No.: US 2006/0039482 A1
(43) Pub. Date: Feb. 23, 2006

(54) Digital broadcasting system for storing broadcast data and method for transmitting and receiving broadcast data

(75) Inventor: Beom-Soo Cho, Gwacheon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/124,829

(22) Filed: May 9, 2005

(30) Foreign Application Priority Data
Aug. 21, 2004 (KR) 66158/2004

(51) Int. Cl. H04N 7/12; H04J 3/07

(52) U.S. Cl. 375/240.26; 370/505

(57) ABSTRACT

Disclosed are a system for storing broadcast data in DMB (digital multimedia broadcasting) and a method for transmitting and receiving broadcast data. A TS multiplexer included in a transmitter of the digital broadcasting system has a flag inserter that inserts an identification flag indicating the start or end of a broadcast program or a highlight of a broadcast program into a TS packet transmitted to the receiver. Also, a TS demultiplexer included in a receiver of the digital broadcasting system has a flag identifier for identifying an identification flag included in a TS packet transmitted from the transmitter and recognizing the start or end of a broadcast program or a highlight based on the identification flag. Accordingly, it is possible to record only the broadcast data corresponding to a specific broadcast program or a highlight of the specific broadcast program as selected by the user.

### PRIORITY

This application claims priority to an application entitled “Digital Broadcasting System for Storing Broadcast Data and Method for Transmitting and Receiving Broadcast Data” filed with the Korean Intellectual Property Office on Aug. 21, 2004 and assigned Serial No. 2004-66158, the contents of which are incorporated herein by reference.

### BACKGROUND OF THE INVENTION

1. Field of the Invention

The present invention relates to a system and method for storing broadcast data in realtime, and more particularly to a system and method for storing broadcast data in a DMB (Digital Multimedia Broadcasting) format.

2. Description of the Related Art

Digital broadcasting generally refers to high-quality audio/video broadcasting services using digital data. Unlike conventional broadcasting services using analog signals, digital broadcasting uses digital data including audio and video data. Digital broadcasting is broadly divided into digital satellite broadcasting using satellites and digital terrestrial broadcasting using VHF channels. Particularly, digital satellite broadcasting using satellites can be received at any time and any place through a handheld digital TV receiver or an in-car digital TV receiver. Although not restricted by place, however, users may not be able to view desired digital broadcasts for various reasons, such as not being in the proximity of a TV receiver or not having time to watch the TV receiver as it receives a broadcast.

In such cases, the digital broadcast data can be stored using a similar recording method as used in analog broadcasting. To be specific, a user can record a desired broadcast program by directly controlling a recording device or by setting a reserve-recording with the start and end times of the broadcast program. When the reserve-recording is used, however, all broadcast data received during the time period set in a timer will be stored. Accordingly, undesirable data such as TV commercials may also be included in the stored data. If the user needs only a small portion of the stored data, most data stored will be unnecessary. In addition, if the user has erred in setting the timer or set a wrong time to reserve recording of a program (based on incorrect information about the broadcast time), or if the broadcast time of the program has changed due to special circumstances of the broadcasting station, the user would, unfortunately, be unable to playback a recording of the desired program.

In view of such disadvantages of reserve-recording, the user may directly control the start and stop of the recording operation on a recorder to record only the desired broadcast data. In some circumstances, however, the user cannot afford to record the desired broadcast data during the broadcast time and even if the user has time to record the broadcast data by operating the recorder, it is cumbersome and inconvenient to directly control the start and stop on the recorder.

In addition, the user cannot fully enjoy viewing recorded digital broadcasts while driving. The user may wish to view summarized news or highlights, instead of an entire broadcast program where the term “highlights” refers to scenes of major importance or special interest in broadcast programs such as news or sport games. Most broadcast programs include highlights that summarize the programs. Moreover, the user can know the issues of the day through highlights in news, even without viewing the entire broadcast news. Furthermore, highlights can show the user results of a sports game which was broadcast over TV.

A viewer can understand a full broadcast program by viewing highlights of the program. However, while most programs are broadcasted at scheduled times, the broadcast times of highlights are variable. Highlights may be included in the beginning, middle or end of a broadcast program. Since it is not certain when the highlights are broadcasted, the conventional reserve-recording is not useful when the user wishes to record only the highlights. The user has to directly operate the recorder to record the highlight data only.

### SUMMARY OF THE INVENTION

Accordingly, the present invention has been made to solve the above-mentioned problems occurring in the prior art, and an object of the present invention is to provide a system and method for storing only desired broadcast data in digital broadcasting, even without a user's direct control.

Another object of the present invention is to provide a system and method for storing only highlight data of a broadcast program in digital broadcasting.

In order to accomplish the above objects of the present invention, there is provided a system for storing broadcast data in digital broadcasting, which includes a transmitter for inserting a flag indicating the start or end of a specific block of broadcast data provided in digital broadcasting into a transport stream packet of the broadcast data and transmitting the transport stream packet with the flag, and a receiver for identifying the flag inserted into the received transport stream packet and storing the broadcast data according to the results of flag identification.

In accordance with another aspect of the present invention, there is provided a method for transmitting broadcast data in a digital broadcasting system, which includes the steps of identifying the start or end of a specific block of broadcast data provided in digital broadcasting, and inserting an identification flag indicating the start or end of the specific block into the broadcast data according to the results of identification and sending the broadcast data with the identification flag inserted.

In accordance with still another aspect of the present invention, there is provided a method for receiving broadcast data in a digital broadcasting system, which includes the steps of receiving broadcast data and detecting an identification flag indicating the start or end of a specific block of the broadcast data, when an identification flag is detected in the broadcast data, determining whether a user has selected storage of the specific block of the broadcast data, when storage of the specific block has been selected, determining whether the identification flag indicates the start or end of the specific block, when the flag indicates the start, storing the received broadcast data, and when the flag indicates the end, terminating the storage of the broadcast data.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the structure of a transmitter of a conventional digital broadcasting system;

FIG. 2 is a block diagram illustrating the structure of a receiver of a conventional digital broadcasting system;

FIG. 3 is a view illustrating Transport Stream (TS) multiplexed data in a conventional digital broadcasting system;

FIG. 4 is a view illustrating the flow of TS multiplexed data in a conventional digital broadcasting system;

FIG. 5 is a block diagram illustrating the structure of a transmitter of a digital broadcasting system according to the present invention;

FIG. 6 is a flow chart illustrating the operation of a TS multiplexer of a digital broadcasting system according to the present invention;

FIG. 7 is a block diagram illustrating the structure of a receiver of a digital broadcasting system according to the present invention;

FIG. 8 is a flow chart illustrating the operation of a TS demultiplexer of a digital broadcasting system according to the present invention; and

FIG. 9 is a view illustrating the storage of news highlights according to the present invention.

### DETAILED DESCRIPTION OF THE PREFERRED EMBODIMENT

Hereinafter, preferred embodiments of the present invention will be described with reference to the accompanying drawings. In addition, in the following description of the present invention, a detailed description of known functions and configurations incorporated herein will be omitted when it may make the subject matter of the present invention unclear.

As a means for storing data of a broadcast program or highlights of a program being broadcasted, preset identification flags are used in both a transmitter and a receiver of a digital broadcasting system. When the transmitter of the digital broadcasting system transmits broadcast data corresponding to a broadcast program or a highlight thereof, it includes an identification flag in the transmitted broadcast data in order to inform the receiver of the transmission of the data.

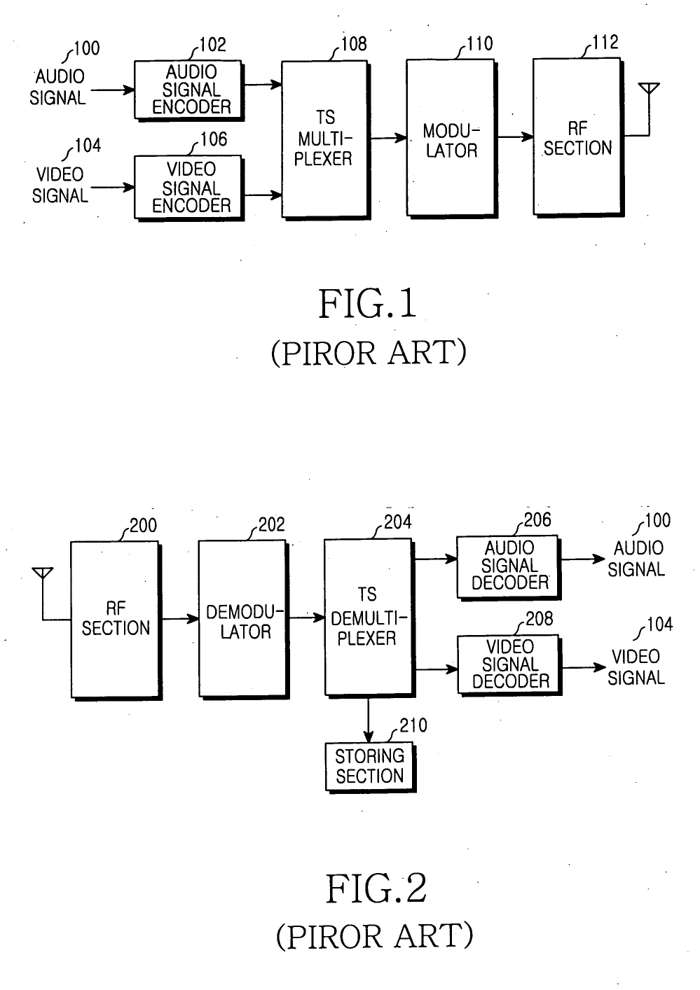

FIGS. 1 to 4 illustrate a conventional digital broadcasting system. FIG. 1 shows the structure of a transmitter of a conventional digital broadcasting system. The transmitter of a conventional digital broadcasting system includes: an audio signal encoder 102 for encoding an inputted analog audio signal 100 into digital audio data and compressing the encoded data; a video data encoder 106 for encoding an analog video signal 104 into digital video data; a TS (Transport Stream) multiplexer 108 for splitting inputted digital audio and video data into TS (Transport Stream) packets to be carried on a transmission channel and multiplexing the TS packets; a modulator 110 for carrying the TS packets received from the TS multiplexer on a carrier wave; and an RF section 112 for sending the TS packets modulated by the modulator 110 as RF (Radio Frequency) signals.

FIG. 2 illustrates the structure of a receiver of a conventional digital broadcasting system for receiving digital broadcast data transmitted from the transmitter in FIG. 1, restoring analog audio and video data from the received broadcast data and outputting the analog audio and video data. The receiver of the conventional digital broadcasting system includes: an RF section 200 for receiving RF signals transmitted from the transmitter; a demodulator 202 for removing a carrier wave from the received RF signals and demodulating the RF signals to a digital data stream; a TS demultiplexer 204 for demultiplexing the digital data stream demodulated by the demodulator 202 to divide it into an audio data stream and a video data stream; a storing section 210 for storing digital broadcast data according to the control of a user; an audio data decoder 206 for decoding the audio data stream inputted from the TS demultiplexer 204 into an analog audio signal 100 and outputting the analog audio signal 100; and a video data decoder 208 for decoding the video data steam inputted from the TS demultiplexer 204 into an analog video signal 104 and outputting the analog video signal 104.

In the digital broadcasting system as shown in FIGS. 1 and 2, encoded audio and video data should be multiplexed and packetized into TS packets to be transmitted from the transmitter to the receiver through a transmission channel. To be more specific, when the audio signal 100 and the video signal 104 are inputted respectively to the audio signal encoder 102 and the video signal encoder 106 as shown in FIG. 1, the audio signal encoder 102 and the video signal encoder 106 encode the inputted analog audio and video signals into digital audio and video data by various methods such as quantization. The encoded digital audio data and video data are packetized at specific time intervals and inputted to the TS multiplexer 108.

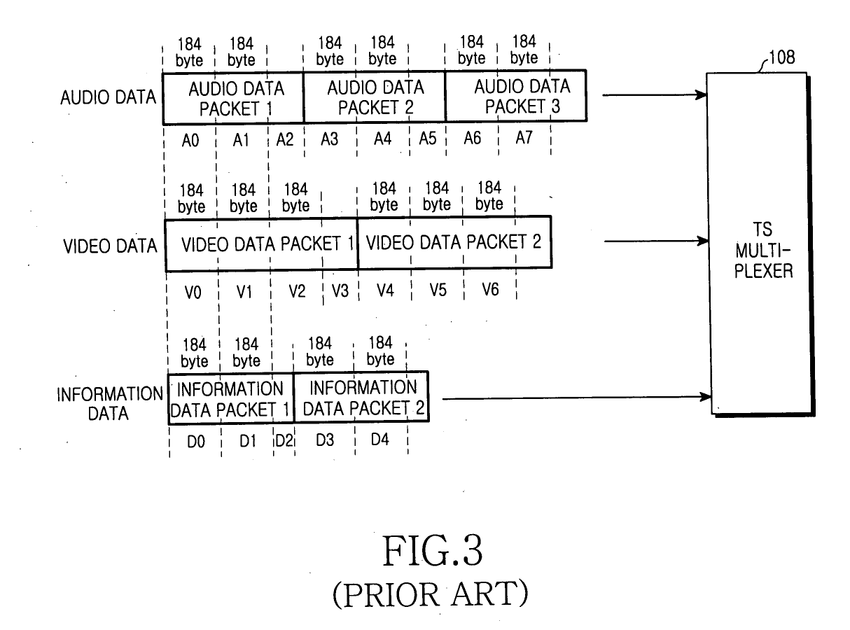

FIG. 3 shows packets of digital audio data, digital video data and information data inputted to the TS multiplexer 108 (audio data packets, video data packets and information data packets). The information data packets relate to information provided in response to a demand from the user, such as traffic information and weather information, rather than broadcast data. The data packets inputted to the TS multiplexer 108 are split into a TS packet size (184 bytes) to be carried on a transmission channel to the receiver. An audio data packet 1 is split into three TS packets A0, A1 and A2. Audio data packets 2 and 3, video data packets and information data packets are each split into 184-byte TS packets. These split data packets are multiplexed into a single stream by the TS multiplexer 108. It is assumed that each TS packet is of 184 bytes according to a protocol for transmitting video, audio and information data packets simultaneously to a single stream in an MPEG-2 system. If another protocol is used, the TS multiplexer 108 will split each data packet into TS packets of a different size according to the other protocol.

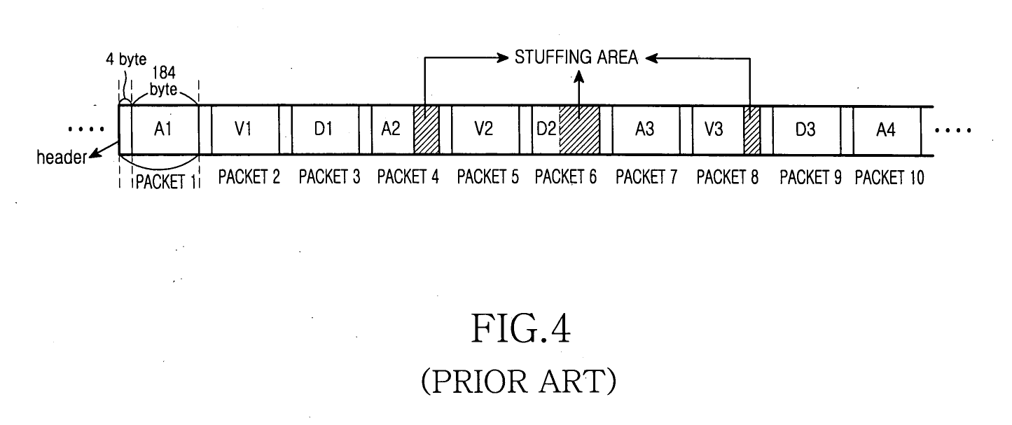

FIG. 4 illustrates the flow of TS multiplexed data packets in FIG. 3. The TS multiplexed data packets include some packets that are smaller than the required TS packet size of 184 bytes. Specifically, audio data packet A2, information data packet D2 and video data packet V3 which are the real data of TS packets 4, 6 and 8, respectively, are smaller than 184-bytes. Accordingly, TS packets 4, 6 and 8 include stuffing areas to fill up the data packets A2, D2 and V3 to the required size.

In accordance with the present invention, identification flags are included in such stuffing areas to inform the receiver of the start or end of broadcast data when each broadcast program is broadcasted and when a highlight of each program is broadcasted. A first embodiment of the present invention is applicable to inform the start and end of broadcast data corresponding to a highlight of a broadcast program, while a second embodiment of the present invention is applicable to inform the start and end of a broadcast program.

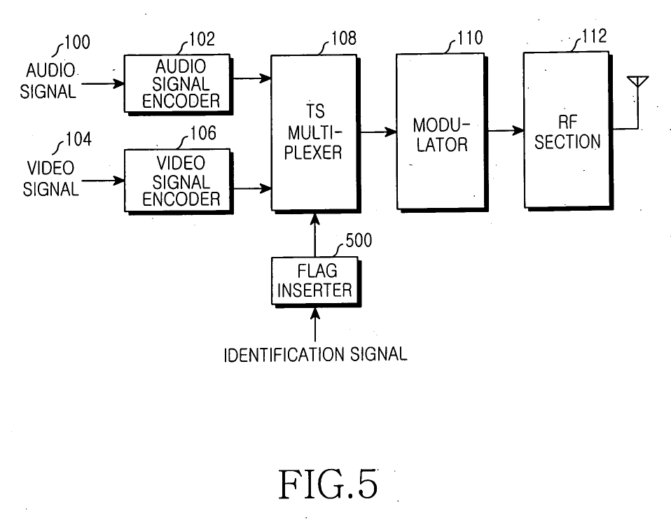

FIG. 5 is a block diagram illustrating the structure of a transmitter of a digital broadcasting system according to the present invention. The transmitter of the present invention further includes a flag inserter 500 in a TS multiplexer 108, as compared to the transmitter of a conventional digital broadcasting system. According to the first embodiment of the present invention, the flag inserter 500 receives an identification signal from a producer of a highlight of a broadcast program or from a highlight broadcasting software or system when the highlight is started or ended, and records a highlight identification flag in the TS packets that have been packetized by the TS multiplexer. The “highlight identification flag” includes a highlight start flag and a highlight end flag that indicate the start and end of the highlight broadcast data.

According to the second embodiment of the present invention, the flag inserter 500 receives an identification signal from a producer of a broadcast program or from a program broadcasting software or system when the program is started or ended, and records a broadcast program identification flag in the TS packets that have been packetized by the TS multiplexer. The “broadcast program identification flag” includes a broadcast program start flag and a broadcast program end flag that indicate the start and end of the broadcast program.

According to the first embodiment of the present invention, when an identification signal indicating the start of a highlight of a broadcast program is inputted, the flag inserter 500 records a highlight identification flag in the stuffing area of a TS packet transmitted at the point of input of the identification signal in order to inform the receiver that the highlight is started. According to the second embodiment of the present invention, when an identification signal indicating the start of a broadcast program is inputted, the flag inserter 500 records a broadcast program identification flag in the stuffing area of one of TS packets that have been packetized from video data packets. As explained above, the identification flag inserted in the stuffing area by the flag inserter 500 according to the first or second embodiment of the present invention is transmitted together with the broadcast data to the receiver through the modulator 110 and RF section 112 of the transmitter.

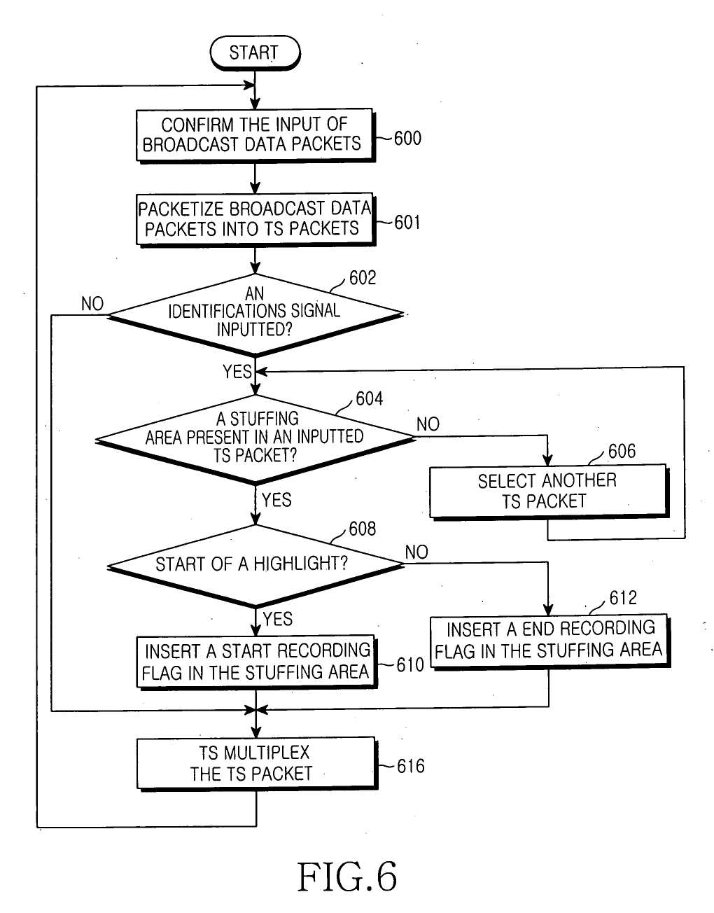

FIG. 6 is a flow chart illustrating the operation of the TS multiplexer 508 that includes the flag inserter 500 for recording a flag in a stuffing area. Either a highlight identification flag or a broadcast program identification flag can be recorded in a stuffing area according to the first or second embodiment of the present invention. For explanatory convenience, however, only the first embodiment of the present invention will be explained with reference to FIG. 6. The TS multiplexer 508 confirms the input of broadcast data packets at step 600. The broadcast data packets include video data packets and audio data packets. At step 601, the TS multiplexer 508 packetizes the inputted broadcast data packets by splitting them into a TS packet of a desired size.

At step 602, the flag inserter 500 confirms whether an identification signal indicating the start or end of a highlight of a broadcast program has been inputted from a producer of the broadcast program or from a highlight broadcasting software or system. If no identification signal is received together with broadcast data packets currently being inputted, the TS multiplexer 508 will proceed with step 616 to multiplex the TS packetized broadcast data packets (hereinafter referred to as “TS packets”) and output the multiplexed TS packets to the modulator 110.

Otherwise, if an identification signal is received at step 602, the TS multiplexer 508 will proceed with step 604 to determine whether a TS packet transmitted at the point of input of the identification signal, among the TS packets that have been TS packetized at step 601, includes a stuffing area. If there is no stuffing area, the TS multiplexer 508 will select another TS packet at step 606 and will proceed with step 604 to determine whether the other TS packet includes a stuffing area. If the other TS packet has a stuffing area which is not sufficiently large to record the flag, the TS multiplexer 508 will regard the other TS packet as having no stuffing area and will proceed with step 606 again.

If a stuffing area is found in a TS packet at step 604, the flag inserter 500 will proceed with step 608 to determine whether the identification signal inputted at step 600 indicates the start or the end of the highlight. If the identification signal inputted to the flag inserter 500 at step 600 indicates the start of the highlight, the flag inserter 500 will proceed with step 610 to record a highlight start flag in the stuffing area of the TS packet found at step 604. On the other hand, if the identification signal inputted to the flag inserter 500 at step 600 indicates the end of the highlight, the flag inserter 500 will proceed with step 612 to record a highlight end flag in the stuffing area of the TS packet found at step 604.

Upon completion of step 610 or 612, the TS multiplexer 508 proceeds with step 616 to multiplex the TS packet with the highlight start or end flag recorded in its stuffing area and output the multiplexed TS packet to the modulator 110. The modulator 110 modulates the received TS packet and transmits the modulated TS packet through the RF section 112.

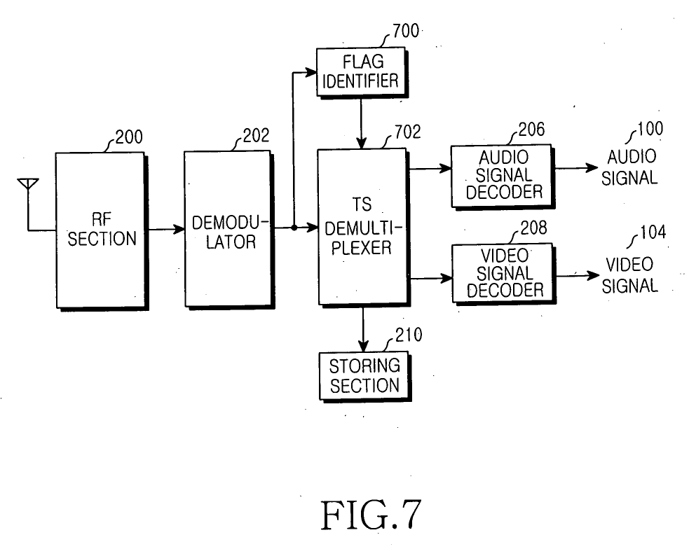

The TS packet transmitted from the transmitter of the digital broadcasting system is received by a receiver of the same system. FIG. 7 is a block diagram illustrating the structure of the receiver of the digital broadcasting system according to the present invention. The receiver according to the present invention, similar to a receiver of a conventional digital broadcasting system, includes an RF section 200 for receiving an RF signal transmitted from the transmitter, a demodulator 202 for demodulating the received RF signal into TS packets, a TS demultiplexer 702 for demultiplexing the demodulated TS packets, a storing section 210 for storing digital data, an audio data decoder 206 for decoding audio data packets demultiplexed by the TS demultiplexer 702, and a video data decoder 208 for decoding video data packets demultiplexed by the TS demultiplexer 702. The receiver according to the present invention further includes a flag identifier 700 for identifying a flag recorded in the stuffing area of a TS packet to indicate the start or end of a highlight. The flag identifier 700 stores highlight start flags and highlight end flags according to the first embodiment of the present invention. Alternatively, the flag identifier 700 may store broadcast program start flags and broadcast program end flags according to the second embodiment of the present invention.

If the receiver of the digital broadcasting system activates a highlight record function according to the first embodiment of the present invention, it will receive a highlight start flag from the transmitter when a highlight of a broadcast program is started. The receiver recognizes the start of the highlight upon receiving the highlight start flag and stores broadcast data corresponding to the received highlight. When the highlight is ended, the receiver receives a highlight end flag and recognizes the end of the highlight accordingly. The receiver then terminates storing the broadcast data.

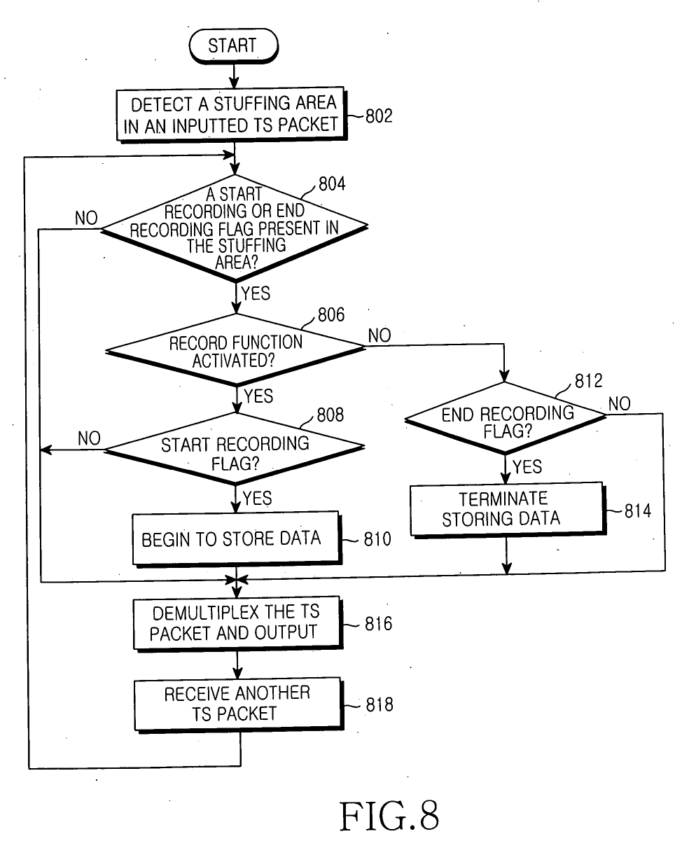

FIG. 8 is a flow chart illustrating the operation of the TS demultiplexer 702 including the flag identifier 700 according to the present invention. The flag identifier 700 can identify both a highlight identification flag according to the first embodiment of the present invention and a broadcast program identification flag according to the second embodiment of the present invention. For explanatory convenience, however, only the first embodiment of the present invention will be explained with reference to FIG. 8.

When a TS packet is inputted from the demodulator 202, the TS demultiplexer 702 proceeds with step 802 to determine whether the inputted TS packet has a stuffing area. At step 804, the TS demultiplexer 702 determines whether a highlight start flag or a highlight end flag is present in the stuffing area of the inputted TS packet. If neither a highlight start flag nor a highlight end flag is present in the stuffing area, the TS demultiplexer 702 will proceed with step 816 to demultiplex the inputted TS packet into audio data packets and video data packets. Subsequently, the TS demultiplexer 702 receives another TS packet at step 818 and proceeds again with step 802 to confirm whether the other TS packet has a stuffing area.

At step 804, the TS demultiplexer 702 determines whether a highlight start flag or a highlight end flag is present in the stuffing area confirmed at step 802. If a highlight start flag or a highlight end flag is found, the TS demultiplexer 702 will proceed with step 806 to confirm whether the user has activated the highlight record function. If the highlight record function is not activated, the TS demultiplexer 702 will proceed with step 816 to demultiplex the TS packet into audio data packets and video data packets and output the audio data packets and the video data packets to the decoders 206 and 208, respectively. Subsequently, the TS demultiplexer 702 receives still another inputted TS packet at step 818 and proceeds again with step 802 to confirm whether the newly inputted TS packet has a stuffing area. If the highlight record function is activated, the TS demultiplexer 702 will proceed with step 808 to have the flag identifier 700 confirm whether the identification flag detected at step 804 is a highlight start flag. When the identification flag detected at step 804 is identical to a previously stored highlight start flag, the flag identifier 700 informs the TS demultiplexer 702 accordingly at step 810. Then the TS demultiplexer 702 stores the inputted broadcast data packets in the storing section 210. On the other hand, if the flag identifier 700 confirms at step 808 that the identification flag present in the stuffing area of the newly inputted TS packet is not a highlight start flag, it will proceed with step 812 to determine whether the identification flag is identical to a previously stored highlight end flag. If the identification flag is determined to be a highlight end flag, the flag identifier 700 will inform the TS demultiplexer 702 accordingly at step 814 so that the TS demultiplexer 702 will terminate storing the broadcast data packets. Then the TS demultiplexer proceeds again with step 816 to demultiplex the TS packet into audio data packets and video data packets and output the audio data packets and the video data packets to the decoders 206 and 208, respectively. The TS demultiplexer 702 receive still another inputted TS packet at step 818 and repeats step 802 to confirm whether the newly inputted TS packet has a stuffing area. According to the first embodiment of the present invention, the digital broadcasting system enables the user to record a highlight of a broadcast program, for example, a sport game, by inputting the broadcast time of the sport game in a timer and setting the highlight record function to be activated during the preset time.

It is also possible to record a digital broadcast program according to the second embodiment of the present invention. To this end, a preset broadcast program start flag and a corresponding broadcast program end flag are used in the transmission of broadcast data from the transmitter to the receiver of the digital broadcasting system. According to the second embodiment of the present invention, the TS packet transmitted with the start of a broadcast program includes a broadcast program start flag. When receiving the TS packet including the broadcast program start flag, the receiver recognizes that the broadcast program has started. If the user has selected a desired broadcast program and set a record function to be activated for the program, the broadcast program will be easily stored, regardless of any change in broadcast time due to special circumstances of the broadcasting station. Table 1 shows broadcast program start flags and corresponding end flags used to record respective broadcast programs.

TABLE 1

| Broadcast program | Program start flag | Program end flag |
|---|---|---|
| Sport Relay Base | 0000 0000 | 1000 0000 |
| News at Nine | 0000 0001 | 1000 0001 |
| Weekend Movie | 0000 0010 | 1000 0010 |
| Soccer Match (Korea : Japan) | 0000 0011 | 1000 0011 |
| Relay of Entertainment Society | 0000 0100 | 1000 0100 |

Referring to Table 1, the broadcast data of soccer match (Korea:Japan) has a broadcast program start flag of 0000 0011 (binary) and a broadcast program end flag of 1000 0011. When the broadcast of the soccer match (Korea:Japan) is started, an identification signal informing the start of the broadcast is inputted to the flag inserter according to the second embodiment of the present invention. With the transmission of the realtime broadcast data of the soccer match, the flag inserter records the broadcast program start flag 0000 0011 in the stuffing area of one TS packet transmitted at the starting point of the broadcast. Upon receiving the TS packet, the receiver according to the second embodiment identifies the broadcast program start flag 0000 0011 included in the TS packet and recognizes that the broadcast of the soccer match (Korea:Japan) has started. At this time, the TS demultiplexer 702 of the receiver confirms whether the record function is activated. If the record function is activated, the TS demultiplexer 702 confirms whether the broadcast program start flag 0000 0011 is identical to that previously set by the user to record the broadcast program. If so, the TS demultiplexer 702 stores broadcast data packets being received in the storing section 210 until the broadcast program end flag 1000 0011 is detected.

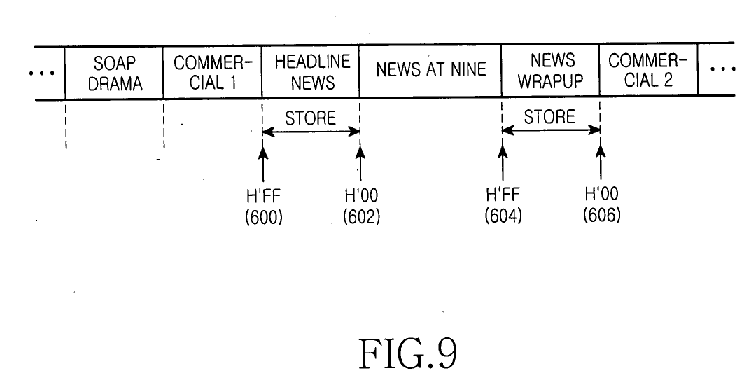

FIG. 9 is a view showing the recording of headline news and news wrapup which are the highlights of news broadcast according to the first embodiment of the present invention. When the highlights of News at Nine, i.e., headlines news or wrapup, are started, the receiver receives a highlight start flag of 0001 0000. Then the receiver stores the broadcast data packets inputted after receiving the highlight start flag. When the headline news and the news wrapup are ended, the receiver receives a highlight end flag of 1000 0001 and terminates storing the broadcast data (moving image data) packets accordingly. Therefore, although the news wrapup is included in the broadcast data of News at Nine, it is possible to record only the news wrapup, without recording the full broadcast data of News at Nine.

In accordance with the first and second embodiments of the present invention, the TS multiplexer included in the transmitter of the digital broadcasting system has a flag inserter that inserts an identification flag indicating the start or end of a broadcast program or a highlight of the program into a TS packet transmitted to the receiver. When the TS packet with an identification flag corresponding to the start or end of a broadcast program or a highlight is sent to the receiver, the TS demultiplexer of the receiver of the digital broadcasting system identifies the identification flag included in the TS packet by means of its flag identifier and recognizes the start or end of the broadcast program or the highlight based on the identification flag. Therefore, the receiver can store the broadcast data packets of the broadcast program or only the highlight for which the record function has been set by the user.

As explained above, the TS multiplexer included in the transmitter of the digital broadcasting system has a flag inserter that inserts an identification flag indicating the start or end of a broadcast program or a highlight of a broadcast program into a TS packet transmitted to the receiver. Also, the TS demultiplexer included in the receiver has a flag identifier for identifying an identification flag included in a TS packet transmitted from the transmitter and recognizing the start or end of a broadcast program or a highlight based on the identification flag. Accordingly, it is possible to record only the moving image data of a desired broadcast program or highlight as selected by the user.

Although preferred embodiments of the present invention have been described for illustrative purposes, those skilled in the art will appreciate that various modifications, additions and substitutions are possible, without departing from the scope and spirit of the invention. In the above description of the present invention, only the recording of a highlight of a broadcast program according to the first embodiment of the present invention has been explained. Although not explained above, full data of a broadcast program can be recorded according to the second embodiment of the present invention. It is also possible to separately record a highlight of a broadcast program while recording the broadcast program as a whole. For example, when the user wishes to separately record the highlights of News at Nine while recording the news program as a whole, he or she can set the receiver to activate the record function for both News at Nine and the highlights thereof. Then the receiver of the digital broadcasting system detects a broadcast program start flag indicating the start of News at Nine, as well as a highlight start flag indicating the start of a highlight of News at Nine, in the stuffing area of a received TS packet. Accordingly, when News at Nine is started, the receiver begins to store the full broadcast data of News at Nine based on the broadcast program start flag. When a highlight is started during storage of the broadcast data of News at Nine, the receiver also begins to separately store the highlight data based on the highlight start flag indicating the start of the highlight. Of course, the full broadcast data of News at Nine and the highlight data are separately stored to be reproduced independently.

The receiver terminates storing the broadcast data of News at Nine and the highlight thereof upon receiving corresponding end flags. To be specific, when a highlight end flag corresponding to the highlight start flag indicating the start of the highlight is received, the receiver terminates storing the highlight data. When a broadcast program end flag corresponding to the broadcast program start flag indicating the start of News at Nine is received, the receiver then terminates storing the broadcast data of News at Nine. Accordingly, various modifications, additions and substitutions can be made to the present invention, without departing from the scope and spirit of the invention as disclosed in the accompanying claims, including the full scope of equivalents thereof.

What is claimed is:

1. A digital broadcasting system comprising:
a transmitter for transmitting broadcast data to a receiver of the digital broadcasting system; and
a flag inserter included in the transmitter to insert a flag indicating a specific block of the transmitted broadcast data.

2. The digital broadcasting system as claimed in claim 1, wherein said flag inserter receives an identification signal informing of at least one of the start and end of a specific block of a broadcast program to identify the start or end of the specific block.

3. The digital broadcasting system as claimed in claim 1, wherein said flag inserter inserts a flag indicating the specific block into a stuffing area that is a vacant area generated in a Transport Stream (TS) packet of the broadcast data packetized to be transmitted to the receiver from the transmitter.

4. A digital broadcasting system comprising:
a receiver for receiving broadcast data transmitted from a transmitter of the digital broadcasting system;
a flag identifier provided in the receiver to identify a flag which indicates a specific block of data included in the broadcast data; and
a storing section provided in the receiver to store digital broadcast data according to the results of flag identification.

5. A digital broadcasting system comprising:
a transmitter for inserting a flag indicating at least one of the start or end of a specific block of broadcast data provided in digital broadcasting into a TS packet of the broadcast data and transmitting the TS packet with the flag; and
a receiver for identifying the flag inserted into the received TS packet and storing the broadcast data according to the results of flag identification.

6. A digital broadcasting system comprising:
a transmitter for transmitting broadcast data provided in a digital broadcasting format to a receiver of the digital broadcasting system; and
a flag inserter included in the transmitter to insert a flag indicating at least one of the start and end of a broadcast program among the transmitted broadcast data.

7. The digital broadcasting system as claimed in claim 6, wherein said flag inserter receives an identification signal indicating at least one of the start or end of a broadcast program from a producer of the broadcast program or from a software or system for broadcasting the program to identify the start or end of the broadcast program.

8. The digital broadcasting system as claimed in claim 6, wherein said flag inserter inserts a flag indicating at least one of the start or end of the broadcast program into a stuffing area that is a vacant area generated in a TS packet of the broadcast data packetized to be transmitted to the receiver from the transmitter.

9. A digital broadcasting system comprising:
a receiver for receiving broadcast data transmitted from a transmitter of the digital broadcasting system;
a flag identifier provided in the receiver to detect and identify a flag included in the broadcast data to indicate at least one of the start or end of a broadcast program; and
a storing section provided in the receiver to store the broadcast data according to results of the flag identification.

10. The digital broadcasting system as claimed in claim 9, wherein said flag identifier stores previously stored broadcast program start flags and broadcast program end flags that indicate the respective start and end of each broadcast program.

11. A digital broadcasting system comprising:
a transmitter for inserting a flag indicating at least one of the start and end of a broadcast program into a TS packet of corresponding broadcast data and transmitting the TS packet with the inserted flag; and
a receiver for identifying the flag inserted into the received TS packet and storing the broadcast data according to the results of flag identification.

12. The digital broadcasting system as claimed in claim 11, wherein said broadcast data is stored upon detection of a flag indicating the start of a broadcast program selected by the user to be recorded.

13. The digital broadcasting system as claimed in claim 11, wherein storage of said broadcast data is terminated upon detection of a flag indicating the end of a broadcast program selected by the user to be recorded.

14. A method for transmitting broadcast data in a digital broadcasting system, comprising the steps of:
identifying the start or end of a specific block of broadcast data provided in a digital broadcasting; and
inserting an identification flag indicating at least one of the start and end of the specific block into the broadcast data according to the results of identification and transmitting the broadcast data with the identification flag inserted.

15. The method as claimed in claim 14, wherein said identification flag is inserted into a stuffing area that is a vacant area generated in a TS packet of the packetized broadcast data when the TS packet is smaller than a required packet size.

16. The method as claimed in claim 14, wherein said identifying step includes:
receiving an identification signal informing of at least one of the start or end of a specific block of a broadcast program to identify one of the start and end of the specific block; and
confirming one of the start and end of the specific block according to the received identification signal.

17. The method as claimed in claim 15, wherein said identification flag includes at least one of a start flag indicating the start of the specific block and an end flag indicating the end of the specific block.

18. The method as claimed in claim 15, wherein said broadcast data transmitting step includes:
determining whether the stuffing area is large enough to record the identification flag;
selecting another stuffing area, when the stuffing area is not large enough to record the identification flag;
inserting at least one of the start and end flag into the other stuffing area according to the results of said identification of one of the start and end of the specific block; and
transmitting broadcast data with the flag inserted into the stuffing area.

19. The method as claimed in claim 17, wherein said broadcast data transmitting step includes:
determining whether the stuffing area is large enough to record the identification flag;
selecting another stuffing area, when the stuffing area is not large enough to record the identification flag;
inserting at least one of the start and end flag into the other stuffing area according to the results of said identification of one of the start and end of the specific block; and
transmitting broadcast data with the flag inserted into the stuffing area.

20. A method for receiving broadcast data in a digital broadcasting system, comprising the steps of:
receiving broadcast data and detecting an identification flag indicating at least one of the start and end of a specific block of the broadcast data;
determining whether a user has selected storage of the specific block of the broadcast data, if an identification flag is detected in the broadcast data;
determining whether the identification flag indicates one of the start and end of the specific block, if storage of the specific block has been selected;
storing the received broadcast data, if the flag indicates the start; and terminating the storage of the broadcast data if the flag indicates the end of the specific block.

21. The method as claimed in claim 20, wherein said step of determining whether the identification flag indicates one of the start and end of the specific block includes:
comparing the identification flag detected in the broadcast data with previously stored broadcast start flags; and
comparing the identification flag detected in the broadcast data with previously stored broadcast end flags.

22. A method for transmitting broadcast data in a digital broadcasting system, comprising the steps of:
identifying at least one of the start and end of a broadcast program provided in a digital broadcasting; and
inserting an identification flag indicating the one of start and end of the broadcast program according to the results of identification and transmitting broadcast data with the identification flag inserted.

23. The method as claimed in claim 22, wherein said identification flag is inserted into a stuffing area that is a vacant area generated in a TS packet of the packetized broadcast data when the TS packet is smaller than a required packet size.

24. The method as claimed in claim 22, wherein said identifying step includes:
receiving an identification signal informing of one of the start and end of a broadcast program to identify one of the start and end of the broadcast program; and
confirming one of the start and end of the broadcast program according to the received identification signal.

25. The method as claimed in claim 23, wherein said identification flag includes a start flag indicating the start of the broadcast program and an end flag indicating the end of the broadcast program.

26. The method as claimed in claim 25, wherein said start flag is unique to each broadcast program.

27. The method as claimed in claim 25, wherein said end flag is unique to each broadcast program.

28. The method as claimed in claim 23, wherein said broadcast data transmitting step includes:
determining whether the stuffing area is large enough to record the identification flag;
selecting another stuffing area, if the stuffing area is not large enough to record the identification flag;
inserting one of the start and end flag into the other stuffing area according to the results of said identification of one of the start and end of the broadcast program; and
transmitting broadcast data with the flag inserted into the stuffing area.

29. The method as claimed in claim 25, wherein said broadcast data transmitting step includes:
determining whether the stuffing area is large enough to record the identification flag;
selecting another stuffing area, if the stuffing area is not large enough to record the identification flag;
inserting one of the start and end flag into the other stuffing area according to the results of said identification of one of the start and end of the broadcast program; and
transmitting broadcast data with the flag inserted into the stuffing area.

30. A method for receiving broadcast data in a digital broadcasting system, comprising the steps of:
receiving broadcast data and detecting an identification flag indicating one of the start and end of a broadcast program;
determining whether a user has selected storage of the broadcast data corresponding to the broadcast program, when an identification flag is detected in the broadcast data;
determining whether the identification flag indicates one of the start and end of the broadcast program, when storage of the broadcast data has been selected;
storing the received broadcast data, when the flag indicates the start; and
terminating the storage of the broadcast data, when the flag indicates the end.

31. The method as claimed in claim 30, wherein said step of determining whether the identification flag indicates one of the start and end of the broadcast program includes:
comparing the identification flag detected in the broadcast data with previously stored broadcast start flags; and
comparing the identification flag detected in the broadcast data with previously stored broadcast end flags.
